(19) United States
(12) Patent Application Publication
(10) Pub. No.: US 2006/0203830 A1
(43) Pub. Date: Sep. 14, 2006

(54) Semiconductor integrated circuit and test method for the same

(75) Inventor: Yoshiyasu Doi, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/233,106

(22) Filed: Sep. 23, 2005

(30) Foreign Application Priority Data
Mar. 8, 2005 (JP) 2005-064624

(51) Int. Cl. H04L 12/56

(52) U.S. Cl. 370/401

(57) ABSTRACT

In order to enable its testing in the form of including the influence of transmission path, a semiconductor integrated circuit comprising a transmission and a receiving circuit comprises an inserted circuit for receiving an output signal of the transmission circuit and providing the output signal to the receiving circuit; and a switch for connecting the inserted circuit between the output side of the transmission circuit and input side of the receiving circuit, with the transmission circuit comprising a pre-emphasis circuit at a later stage thereof and the receiving circuit comprising an equalizer circuit at a earlier stage thereof, wherein the inserted circuit and switch are connected between an output side of the pre-emphasis circuit and input side of the equalizer circuit.

### CROSS REFERENCE TO RELATED APPLICATIONS

This application is based upon and claims the benefit of priority from the prior Japanese Patent Application No. 2005-064624 filed on Mar. 8, 2005, the entire contents of which are incorporated herein by reference.

### BACKGROUND OF THE INVENTION

1. Field of the Invention

The present invention relates to a semiconductor integrated circuit for transmitting and receiving high speed signals and its test method, and in particular to a semiconductor circuit comprising a pre-emphasis circuit on a high speed transmission circuit side and an equalizer circuit on a high speed receiving circuit side and its test method.

2. Description of the Related Art

In recent years, a high speed serial interface has been in increasingly strong demand due to bus systems being limited in terms of frequency. A change of signal transmission method from the bus system to a serial system has sped up transmission speeds in a signal line greatly, hence requiring a band in the neighborhood of tens of Giga bps (“Gbps” hereinafter). Today, the standards for a high speed serial interface used for a CMOS semiconductor apparatus include fiber channel, PCI express and serial ATA and the like.

As for a backbone communication system, for example, a known method for a data transmission between boards on which LSI is mounted is backplane transmission which uses a transmission speed in the neighborhood of 10 Gbps or 6.4 Gbps. In such signal transmission in the GHz band one can not ignore attenuation or reflection of signals in the signal transmission path such as PCB (printed circuit board), transmission cable and connector.

Accordingly, a high speed serial interface is often equipped with a pre-emphasis circuit on the transmission circuit side for transmitting by emphasizing a high frequency component for example and an equalizer circuit on the receiving circuit side for compensating for attenuation or reflection in order to compensate for the influence of such signal attenuation or signal reflection. The equipment of such a pre-emphasis circuit and equalizer circuit maintains the quality of signals.

Conventionally, testing a semiconductor apparatus such as a semiconductor integrated circuit comprising transmission and receiving circuits employs the method of connecting a tester with each one of every input terminal and measuring an output voltage by applying a logic voltage. Or a testing method is used, in which a low speed testing signal is converted to a high speed signal followed by transmitting from the transmission circuit, converting the high speed signal received by the receiving circuit into a low speed signal and further followed by comparing an expected value with the low speed signal. There is a reference document of a conventional technique relating to such a semiconductor integrated circuit testing method.

[Patent document 1] Japanese laid-open patent application publication No. 2000-171524 “Semiconductor integrated circuit and its testing method”

This document discloses a technique for letting a first logic circuit 111 convert a low speed signal input by an inspection apparatus 101 into a high speed signal and then input to a high speed transmission circuit 105, letting a switch 107 equipped between the high speed transmission circuit 105 and high speed receiving circuit 106 input an output of the high speed transmission circuit 105 directly to the high speed receiving circuit 106, converting the output of the high speed receiving circuit 106 to a low speed signal by a second logic circuit 112 and then comparing the low speed signal with the expected value thereof by a comparator 110 as shown by FIG. 1.

This method, however, is faced with the problem of being unable to effectively test a semiconductor integrated circuit comprising the above described pre-emphasis circuit on the transmission circuit side and equalizer circuit on the receiving circuit side. That is, the pre-emphasis circuit and equalizer circuit are for compensating for an influence of attenuation or reflection of the signal by the transmission path and the like, and therefore testing of a semiconductor integrated circuit comprising these pre-emphasis and equalizer circuits requires an addition of a loss equivalent to that caused by the actual transmission path to a signal prior to the testing, whereas the above noted conventional technique is unable to solve the problem.

In addition, the conventional technique cannot solve the problem of inability to inspect an inclusion of the influence of a transmission path because the inspection is carried out by connecting the high speed transmission circuit to a high speed receiving circuit by the switch directly.

### SUMMARY OF THE INVENTION

A challenge of the present invention, including the target of a semiconductor integrated circuit comprising a pre-emphasis circuit on the transmission circuit side and an equalizer circuit on the receiving circuit side for example, is to provide a semiconductor integrated circuit allowing testing including the influences of the pre-emphasis circuit, equalizer circuit, et cetera, provide a semiconductor integrated circuit allowing testing inclusive of influences of a transmission path even in the case of not comprising a pre-emphasis circuit or equalizer circuit, and enable testing of such a semiconductor integrated circuit by using a low speed inspection apparatus.

A semiconductor integrated circuit according to the present invention, being the one comprising a transmission circuit and a receiving circuit, comprises at least an inserted circuit and a switch.

The inserted circuit is for providing a loss to an output signal of the transmission circuit for example; is for receiving an output signal of the transmission circuit and for providing an output signal to the receiving circuit; while the switch is for connecting the inserted circuit between the output side of the transmission circuit and the input side of the receiving circuit.

Also the semiconductor integrated circuit according to the present invention can also comprise a pre-emphasis circuit for emphasizing a high frequency component of a transmitting signal at a later stage of the transmission circuit, and an equalizer circuit for equalizing a receiving signal at an earlier stage of the receiving circuit.

The semiconductor integrated circuit according to the present invention, likewise comprising transmission and receiving circuits, comprises two external connection terminals for connecting to the inserted circuit for receiving an output signal of the transmission circuit and for providing the output signal to the receiving circuit; and a switch for connecting the two external connection terminals between an output side of the transmission circuit and an input side of the receiving circuit so as to enable connecting a circuit which changes an output signal of the transmission circuit to the external connection terminal.

Furthermore, the semiconductor integrated circuit according to the present invention is the one comprising a transmission circuit for transmitting a high speed signal with a high transfer rate and a receiving circuit for receiving a high speed signal, comprising: a first logic circuit for converting an externally input low speed signal with a low transfer rate into a high speed signal with a high transfer rate to provide to the transmission circuit at the time of testing the semiconductor integrated circuit; an inserted circuit for receiving an output signal of the transmission circuit and providing the output signal to the receiving circuit; a switch for connecting the inserted circuit between an output side of the transmission circuit and an input side of the receiving circuit at the time of testing; and a second logic circuit for converting a high speed signal output from the receiving circuit into a low speed signal to output to the outside at the time of the testing.

Then, a testing method used for a semiconductor integrated circuit comprising a transmission circuit for transmitting a high speed signal with a high transfer rate and a receiving circuit for receiving a high speed signal, comprises the steps of letting an externally input low speed signal with a low transfer rate be converted into a high speed signal and be input to a transmission circuit; letting an output of the transmission circuit be input, for testing the semiconductor integrated circuit, to the inserted circuit which is inserted between the transmission circuit and receiving circuit; converting a high speed signal, to a low speed signal, output from a receiving circuit to which an output of the inserted circuit is input; and comparing the converted low speed signal with an expected value of a test result.

According to the present invention as described above, a semiconductor integrated circuit comprising a pre-emphasis circuit at a later stage of the transmission circuit and an equalizer circuit at an earlier stage of the receiving circuit, for example, is configured to insert an inserted circuit for changing a transmission signal in a way equivalent to the influence of a transmission path so as to provide the receiving circuit the output of the inserted circuit.

According to the present invention, the provided is a semiconductor integrated circuit comprising transmission and receiving circuits which are configured to connect the inserted circuit between the transmission and receiving circuits for providing a influence equivalent to the influence of attenuation and reflection and the like of a signal due to a transmission path, thereby providing a semiconductor integrated circuit enabling testing, and thus making testing easy. Also provided is a semiconductor integrated circuit comprising a transmission circuit for transmitting a high speed signal and a receiving circuit for receiving a high speed signal which comprises an inserted circuit for changing a transmission signal in a way equivalent to an influence of a transmission path, as a semiconductor integrated circuit having a pre-emphasis circuit on the transmission circuit side and an equalizer circuit on the receiving circuit side for example, hence making inspection easy.

### BRIEF DESCRIPTION OF THE DRAWINGS

FIG. 1 is a block diagram showing a conventional comprisal of a semiconductor integrated circuit and its testing system;

FIG. 2 is a block diagram showing the fundamental comprisal of a semiconductor integrated circuit according to the present invention;

FIG. 3 is a block diagram showing a basic comprisal of a semiconductor integrated circuit and its testing system according to the present invention;

FIG. 4 shows an operation time chart of the semiconductor integrated circuit testing system shown by FIG. 3;

FIG. 5 is a block diagram of the first embodiment showing a comprisal of a semiconductor integrated circuit and its testing system;

FIG. 6 describes a first specific example of a loss circuit according to the first embodiment;

FIG. 7 shows a characteristic of an RC filter as the first specific example;

FIG. 8 describes a second specific example of a loss circuit;

FIG. 9 describes a third specific example of a loss circuit;

FIG. 10 describes a fourth specific example of a loss circuit;

FIG. 11 describes a fifth specific example of a loss circuit;

FIG. 12 describes a sixth specific example of a loss circuit;

FIG. 13 describes a seventh specific example of loss circuit;

FIG. 14 is a block diagram of the second embodiment showing a comprisal of a semiconductor integrated circuit and its testing system;

FIG. 15 describes a first specific example of a control circuit according to the second embodiment;

FIG. 16 describes center voltage control operation in the configuration shown by FIG. 15;

FIG. 17 describes a second specific example of a control circuit according to the second embodiment;

FIG. 18 describes the control of amplitude and center voltage in the configuration shown by FIG. 17;

FIG. 19 is a block diagram of the third embodiment showing a comprisal of a semiconductor integrated circuit and its testing system;

FIG. 20 describes delay control operation according to the third embodiment;

FIG. 21 describes control of the relationship between data and a clock according to the third embodiment;

FIG. 22 is a block diagram showing a comprisal of the fourth embodiment;

FIG. 23 is a block diagram showing a comprisal of the fifth embodiment;

FIG. 24 is a block diagram showing a comprisal of the test control circuit according to the fifth embodiment;

FIG. 25 is an example operation time chart of the test control circuit shown by FIG. 24;

FIG. 26 is a block diagram showing a comprisal of the sixth embodiment;

FIG. 27 is a block diagram showing a comprisal of the seventh embodiment;

FIG. 28 is a block diagram showing a comprisal of the eighth embodiment;

FIG. 29 is a block diagram showing a comprisal of the ninth embodiment; and

FIG. 30 describes example input signals to an equalizer circuit according to the eighth and ninth embodiments.

### DESCRIPTION OF THE PREFERRED EMBODIMENTS

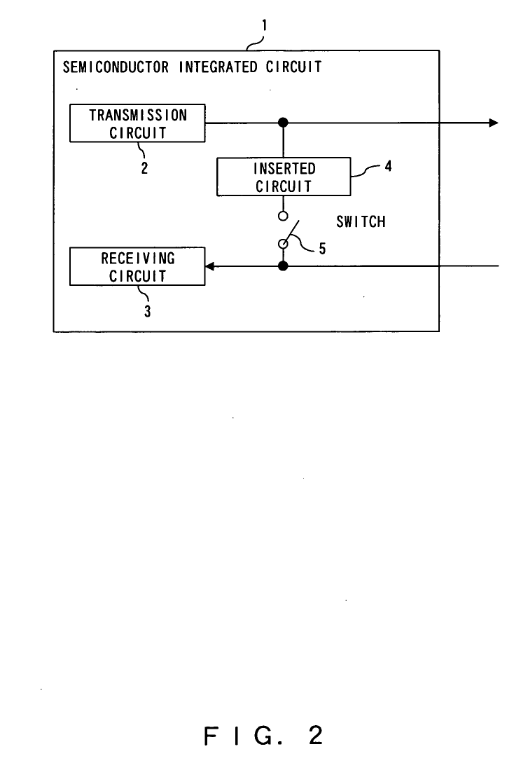

FIG. 2 is a block diagram showing the fundamental comprisal of a semiconductor integrated circuit according to the present invention. In FIG. 2, a semiconductor integrated circuit 1 comprises a transmission circuit 2 and a receiving circuit 3, comprising at least an inserted circuit 4 and a switch 5.

The inserted circuit 4 is for providing a loss to an output signal of the transmission circuit 2 for example; is for receiving an output of the transmission circuit 2 and providing the output signal to the receiving circuit 3; while the switch 5 is for connecting the inserted circuit 4 between the output side of the transmission circuit 2 and the input side of the receiving circuit 3.

Also the semiconductor integrated circuit according to the present invention can also comprise a pre-emphasis circuit for emphasizing a high frequency component of the transmitting signal at a later stage of the transmission circuit 2, and an equalizer circuit for equalizing an receiving signal at an earlier stage of the receiving circuit.

The semiconductor integrated circuit according to the present invention, likewise comprising transmission and receiving circuits, comprises two external connection terminals for connecting to the inserted circuit for receiving an output signal of the transmission circuit and providing the output signal to the receiving circuit, and a switch for connecting the two external connection terminals between an output side of the transmission circuit and input side of the receiving circuit so as to enable a connecting a circuit which changes an output signal of the transmission circuit to the external connection terminal.

Furthermore, the semiconductor integrated circuit according to the present invention comprises a transmission circuit for transmitting a high speed signal with a high transfer rate and a receiving circuit for receiving a high speed signal, comprising: a first logic circuit for converting an externally input low speed signal with a low transfer rate to a high speed signal with a high transfer rate to provide to the transmission circuit at the time of testing the semiconductor integrated circuit; an inserted circuit, receiving an output signal of the transmission circuit, for providing the output signal to the receiving circuit; a switch for connecting the inserted circuit between an output side of the transmission circuit and an input side of the receiving circuit at the time of the testing; and a second logic circuit for converting a high speed signal output from the receiving circuit into a low speed signal to output to the outside at the time of testing.

Then, a testing method used for a semiconductor integrated circuit comprising a transmission circuit for transmitting a high speed signal with a high transfer rate and a receiving circuit for receiving a high speed signal, comprises the steps of allowing an externally input low speed signal with a low transfer rate to be converted into a high speed signal and be input to the transmission circuit; allowing an output of the transmission circuit to be input, for testing the semiconductor integrated circuit, to the inserted circuit which is inserted between the transmission circuit and receiving circuit; converting a high speed signal, to a low speed signal, output from a receiving circuit to which an output of the inserted circuit is input; and comparing the converted low speed signal with an expected value of the test result.

According to the present invention as described above, a semiconductor integrated circuit comprising a pre-emphasis circuit at a later stage of the transmission circuit and an equalizer circuit at an earlier stage of the receiving circuit, for example, is configured to insert an inserted circuit for providing a transmission signal a influence equivalent to the influence of the transmission path so as to provide the receiving circuit the output of the inserted circuit.

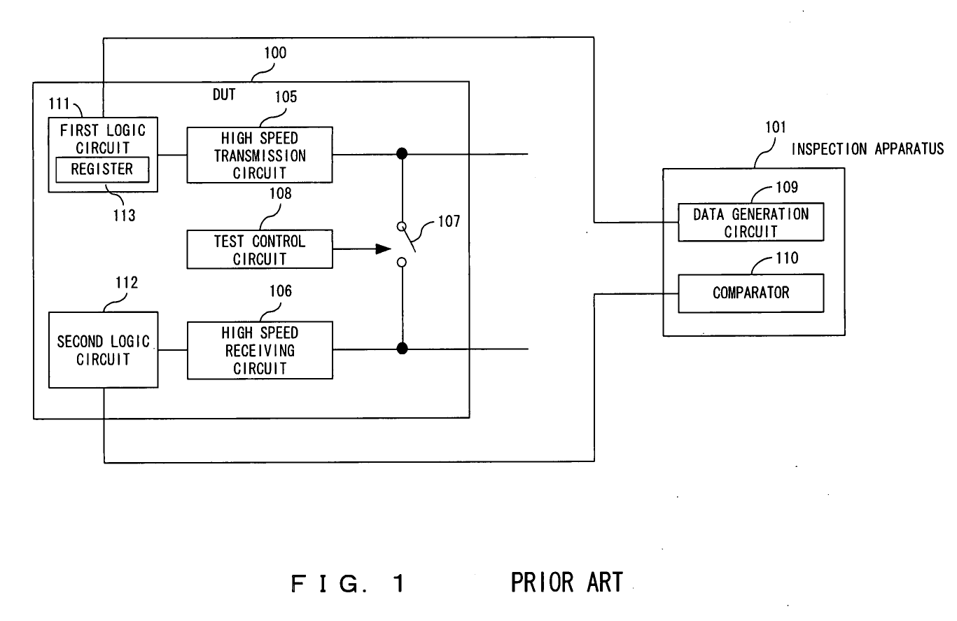

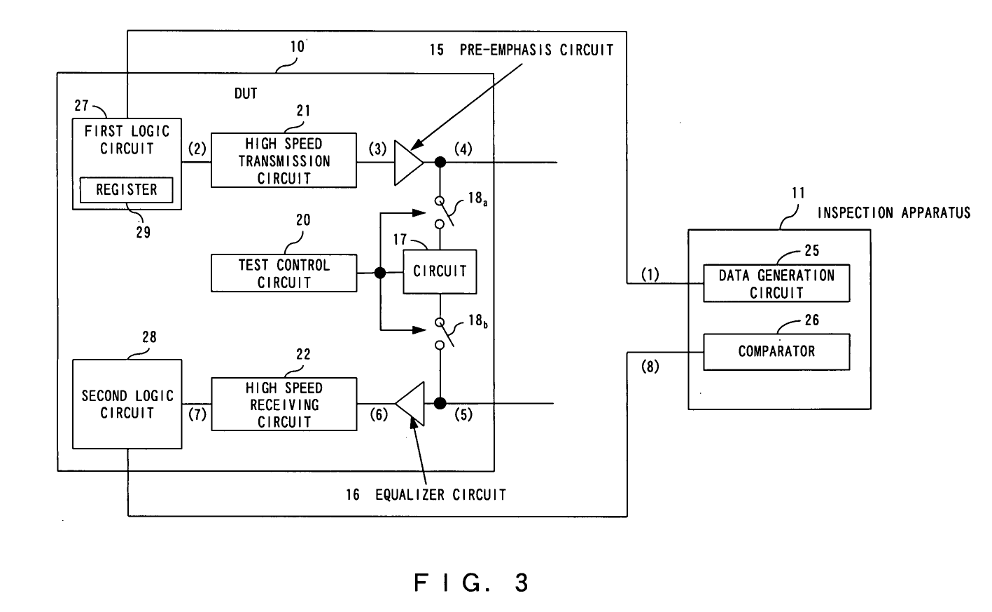

FIG. 3 is a block diagram showing a basic comprisal of a semiconductor integrated circuit and its testing system according to the present invention. As in the conventional system described in association with FIG. 1, a DUT (device under test) 10 as a semiconductor integrated circuit is connected to an inspection apparatus 11.

The present embodiment comprises a pre-emphasis circuit 15 for compensating for an attenuation or reflection, in a transmission path, of a high speed transmission signal output from the DUT 10; an equalizer circuit 16 for cancelling the influence of attenuation or reflection in the transmission path at the time of receiving the signal to maintain its quality; and a circuit 17 for carrying out attenuation, delay or amplification of the signal within the DUT 10 in order to enable testing of the DUT 10 as a semiconductor integrated circuit including the pre-emphasis circuit 15 and equalizer circuit 16. And the circuit 17 is connected between the output side of the pre-emphasis circuit 15 and the input side of the equalizer circuit 16 by way of two switches 18a and 18b, respectively, with on/off control of these switches being performed by the test control circuit 20. Note that these two switches 18a and 18b are, of course, turned off during normal operation of the DUT 10 and therefore the circuit 17 does not influence the operation thereof.

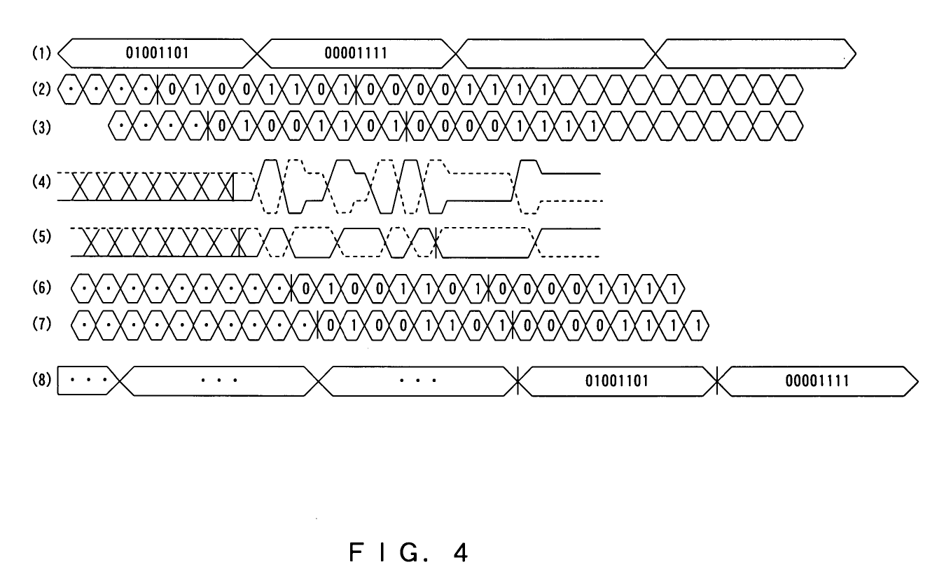

The inspection apparatus 11 carries out testing of the DUT 10 as a semiconductor integrated circuit as in the case of the conventional example shown by FIG. 1. FIG. 4 shows a time chart of the operation of the testing. Referring to FIG. 4, the testing proceeds as numbered as follows: (1) the data generation circuit 25 within the inspection apparatus 11 outputs 8-bit low speed parallel data, e.g., 200 Mbps, for example; (2) the first logic circuit 27 within the DUT 10 converts the low speed data into a high speed serial data, e.g., 10 Gbps, to output by way of the high speed transmission circuit 21 and pre-emphasis circuit 15. The output signal of the high speed transmission circuit 21 is in the form of the output of the first logic circuit 27, being delayed as shown by (3) for example; while the output of the pre-emphasis circuit 15 is in the form of, as shown by (4), a high frequency component being emphasized before modulation for example. Note here that the dotted waveform shows a signal corresponding to a differential circuit applicable to a later described sixth embodiment and embodiments thereafter.

At the time of inspecting the DUT 10, the test control circuit 20 closes the two switches 18a and 18b so that the output of the pre-emphasis circuit 15 is, as shown by (5), provided to the equalizer circuit 16 with its amplitude being attenuated for example by way of the circuit 17 which provides an influence corresponding to the attenuation and/or reflection in a transmission path.

The equalizer circuit 16 compensates for the output signal of the circuit 17 corresponding to the received signal from the transmission path and performs a data judgment for example to output data in the form as shown by (6) to the high speed receiving circuit 22. The high speed receiving circuit 22 outputs a signal shown by (7) as the aforementioned signal being delayed for a certain time; the second logic circuit 28 converts it into a low speed parallel data again to provide to the comparator 26 within the inspection apparatus 11 as a signal shown by (8), so as to compare it with 8-bits of data for example output from the data generation circuit 25 for determination of the bit error rate. Note here that the respective operations of the first logic circuit 27 and second logic circuit 28 are not limited to a serial to parallel conversion, et cetera.

Also note that embodiments of the present invention relate to a semiconductor integrated circuit comprising a pre-emphasis circuit and an equalizer circuit as the subject of the following description, but the present invention can be applied to a semiconductor integrated circuit having no such circuit, in which case insertion of the circuit 17 enables testing comprising the influence of a transmission path.

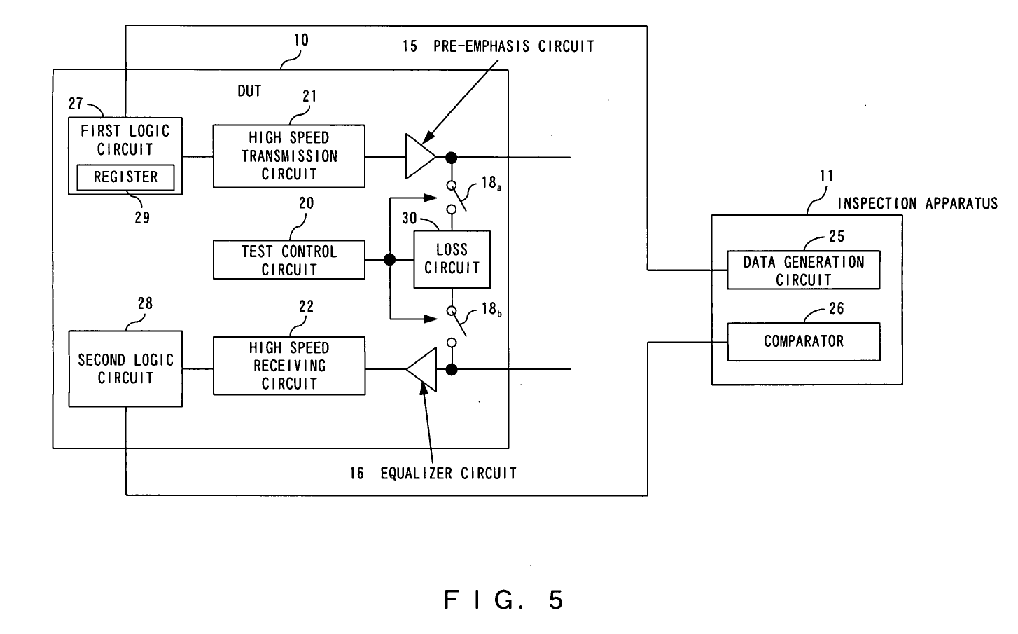

FIG. 5 shows a first embodiment of a semiconductor integrated circuit and its testing system. Comparing FIG. 5 with the basic comprisal block diagram shown by FIG. 3, a loss circuit 30 for providing a loss to a signal is used as the circuit inserted between the output side of the pre-emphasis circuit 15 and the input side of the equalizer circuit 16 at the time of testing the DUT 10.

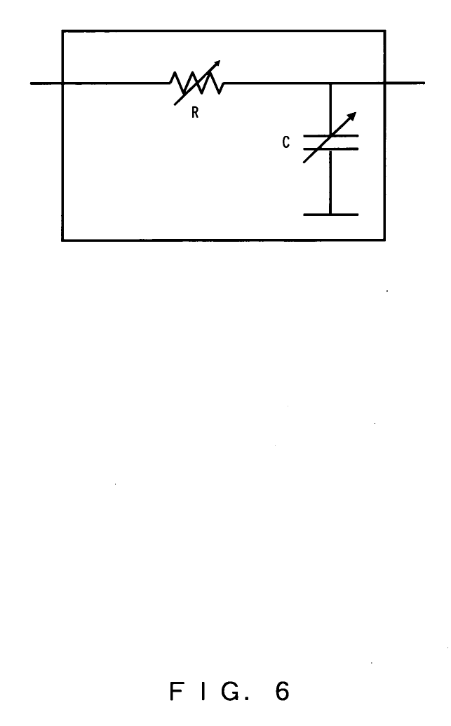

FIG. 6 describes a first specific example of the loss circuit 30 according to the first embodiment. Referring to FIG. 6, the loss circuit 30 comprises a variable resistor R and a variable capacitor C, with each end of the variable resistor R, being connected with the two switches 18a and 18b, respectively, as the terminals on the each end of the loss circuit 30 in the comprisal shown by FIG. 5.

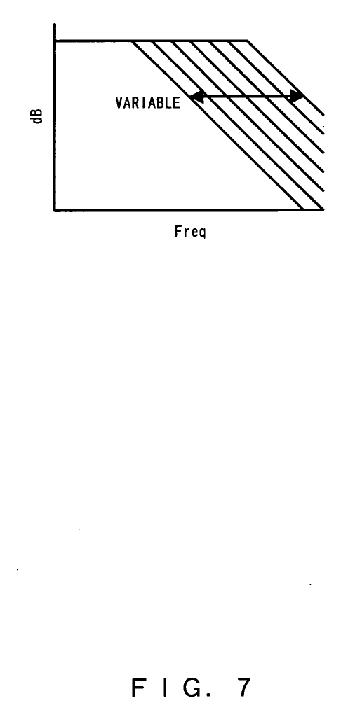

FIG. 7 shows a characteristic of the RC filter shown by FIG. 6. The gain of the RC filter decreases in a high frequency region, but a use of variable capacitor, et cetera, changes the frequency region where the gain decreases.

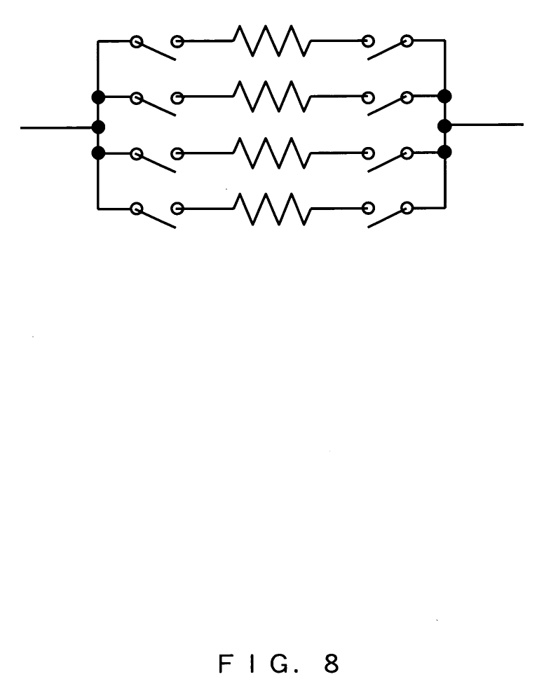

FIG. 8 describes a second specific example of a loss circuit according to the first embodiment. In FIG. 8, an arrangement of a plurality of resistors with the same resistance, and connection of some thereof in parallel by respective switches comprises a loss circuit the entirety being a variable resistor. Such a resistor is accomplished by a poly resistor or a well resistor.

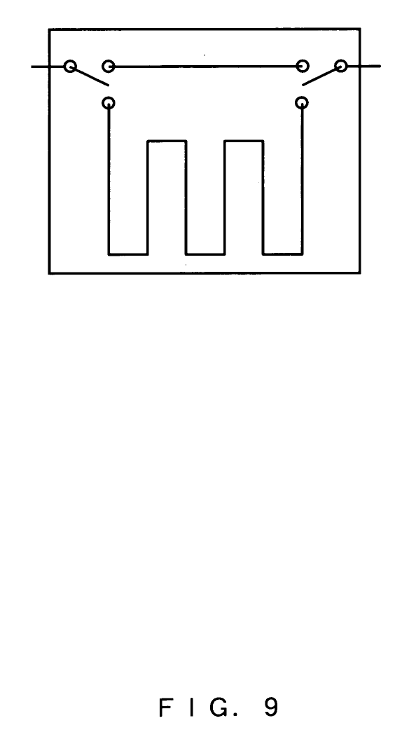

FIG. 9 describes a third specific example of a loss circuit. In this example, a resistance or capacitance component corresponding to the RC filter shown by FIG. 6 for example is accomplished by parasitic resistance or capacitance of the wiring. Incidentally in FIG. 9, closing the two switch actuators makes the state of the loss circuit 30 such that it is not inserted in FIG. 5, that is, the state where only the pre-emphasis circuit 15 and equalizer circuit 16 are connected between the high speed transmission circuit 21 and high speed receiving circuit 22, thus enabling testing of the semiconductor integrated circuit including only the influences of the pre-emphasis circuit 15 and equalizer circuit 16. In such a case, and when inspecting only the influence of a pre-emphasis circuit by controlling the intensities of pre-emphasis and equalization, it is possible to test the influence of the pre-emphasis circuit 15 by controlling the intensity and amount of loss of the pre-emphasis with the gain of the equalizer circuit being one (“1”) in order to reduce the intensity of the equalizer circuit.

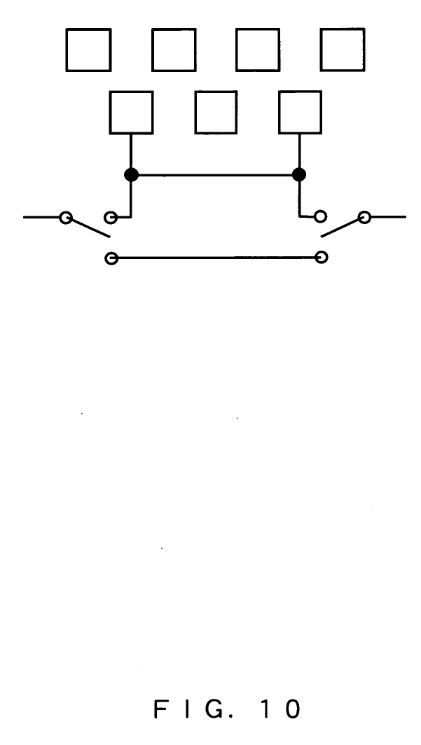

FIG. 10 describes a fourth specific example of a loss circuit according to the first embodiment. In FIG. 10, the wiring is connected to a PAD whose parasitic capacitance is used for accomplishing a loss circuit. A PAD in a semiconductor integrated circuit usually has a large area size, allowing a large parasitic capacitance, hence enabling testing of a semiconductor integrated circuit including the influence of such parasitic capacitance.

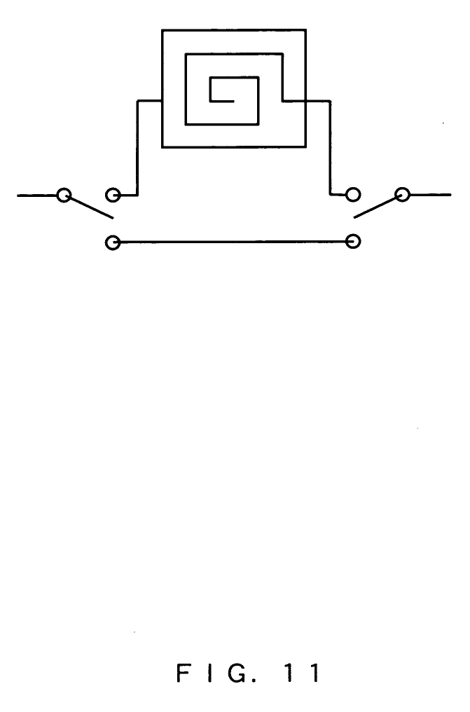

FIG. 11 describes a fifth specific example of a loss circuit. In this example, a loss circuit is accomplished by a spiral inductor formed within a semiconductor integrated circuit. An impedance of the spiral inductor becomes large in a high frequence region, resulting in attenuating a signal.

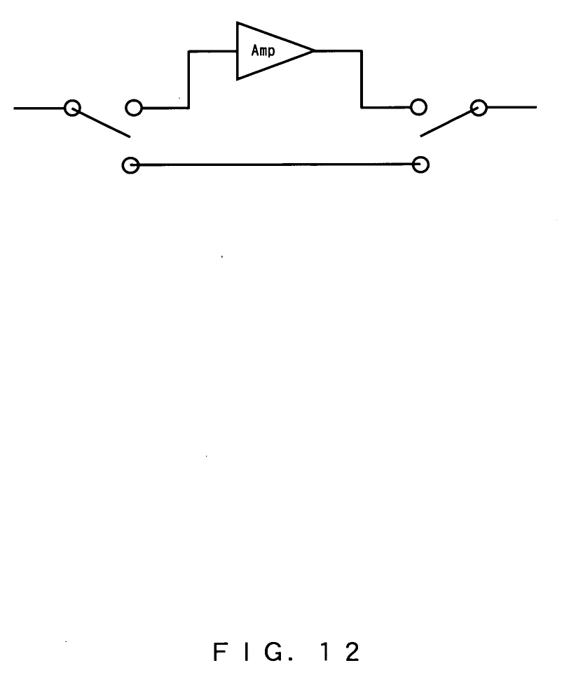

FIG. 12 describes a sixth specific example of a loss circuit. In FIG. 12, a loss circuit is accomplished by a narrow band amplifier. That is, use of a narrow band amplifier makes the gain of the amplifier small in a high frequency region, thus accomplishing attenuation of the signal.

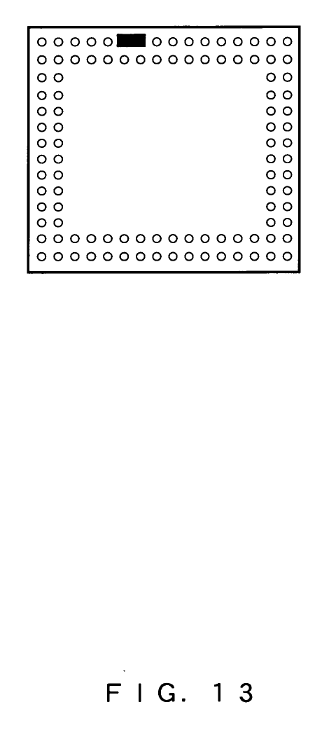

FIG. 13 describes a seventh specific example of a loss circuit. FIG. 13 shows an example accomplishing a loss by connecting solder balls placed on the outer surface of a chip, following mounting a semiconductor apparatus including an integrated circuit onto the chip. The connection of solder balls will be done at the time of testing only and then removed thereafter, hence causing no influence at the time of actual usage.

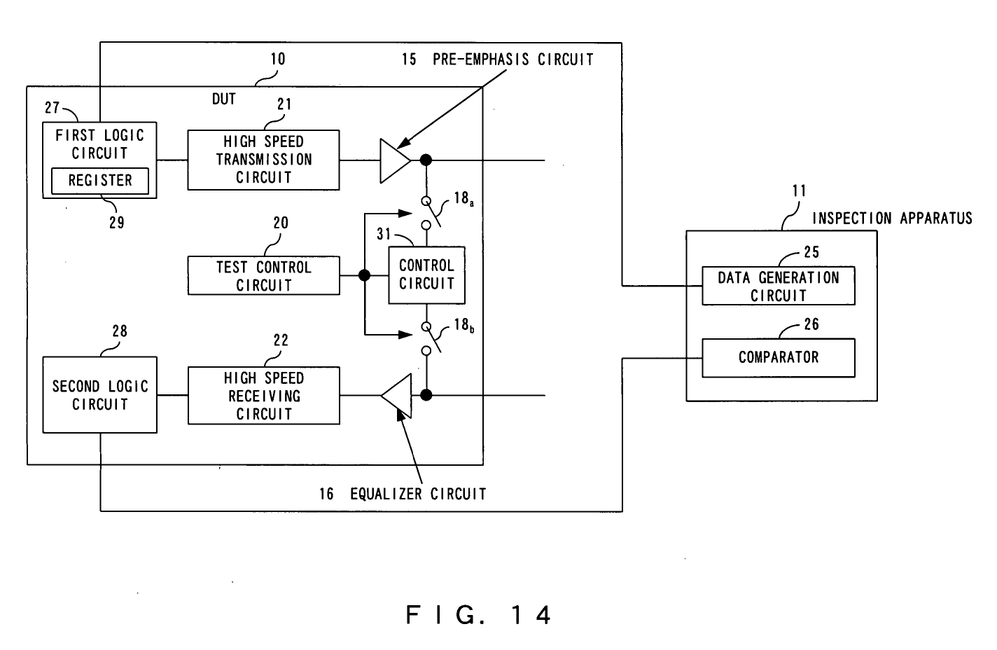

FIG. 14 is a block diagram of a second embodiment showing a comprisal of a semiconductor integrated circuit and its testing system according to the present embodiment. Comparing FIG. 14 with the basic comprisal block diagram shown by FIG. 3, the difference lies in that the former comprises a control circuit 31 for controlling the level and amplitude of a signal in place of the circuit 17 which is inserted between the output side of the pre-emphasis circuit 15 and the input side of the equalizer circuit 16 at the time of testing the DUT 10.

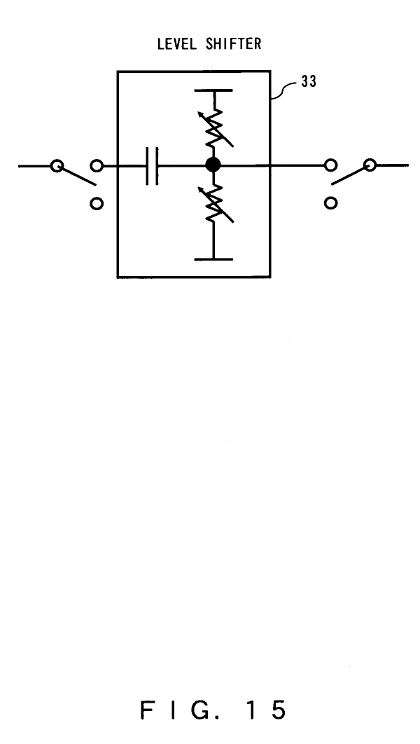

FIG. 15 describes a first specific example of the control circuit 31 according to the second embodiment. In FIG. 15, a level shifter 33 is used as the control circuit 31, thereby enabling control of the center voltage of the signal, that is, the DC component. The DC component of the signal is cut by a capacitor, letting only the AC component pass, while the remaining DC component is set at a discretionary value by the two variable resistors to the right of the drawing.

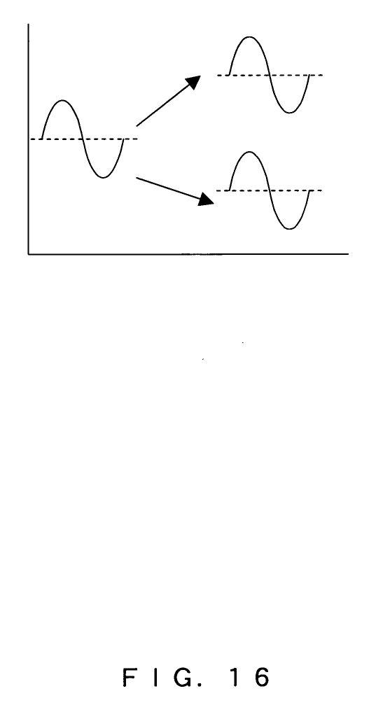

FIG. 16 exemplifies an operation of the level shifter shown by FIG. 15. The operation makes it possible to set the center voltage of the input signal of the equalizer circuit 16 discretionarily, and therefore inspect a characteristic of the equalizer circuit 16 at every operating point (i.e., operating voltage).

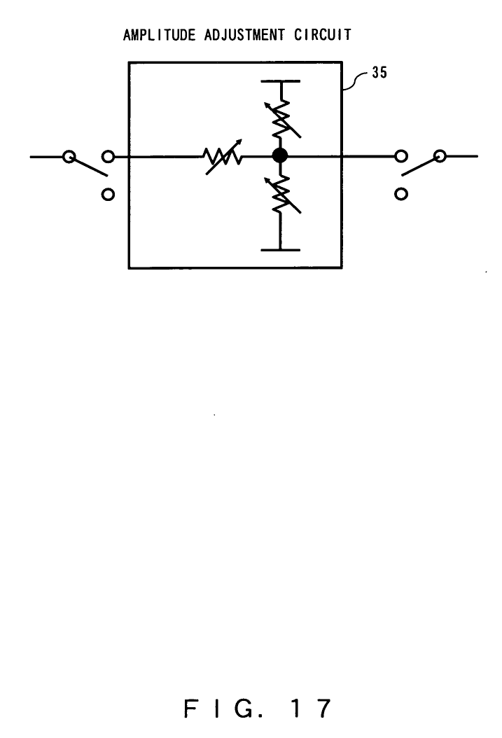

FIG. 17 describes an amplitude adjustment circuit as a second specific example of a control circuit, enabling not only an adjustment of amplitude by a variable resistor connected to the input terminal but also controlling the center voltage of a signal by two variable resistors on the right of the drawing.

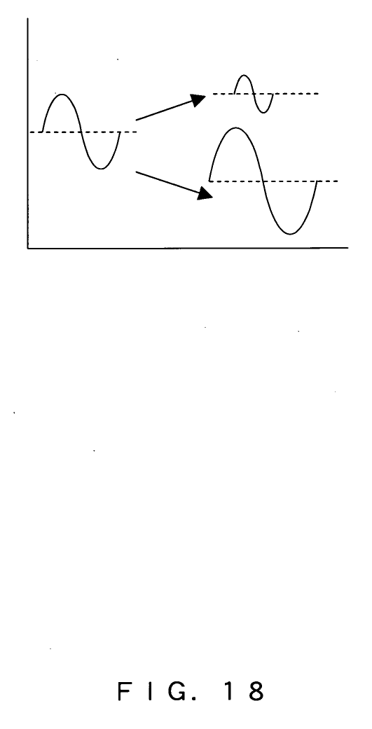

FIG. 18 describes an example operation of the amplitude adjustment circuit shown by FIG. 17. The operation enables control of the amplitude as well as the center voltage of a signal, and an inspection of the equalizer circuit 16 and receiving sensitivity of the entirety by making the amplitude of the input signal of the equalizer circuit 16 small. Such an amplitude adjustment circuit can also utilize a variable limiting amplifier.

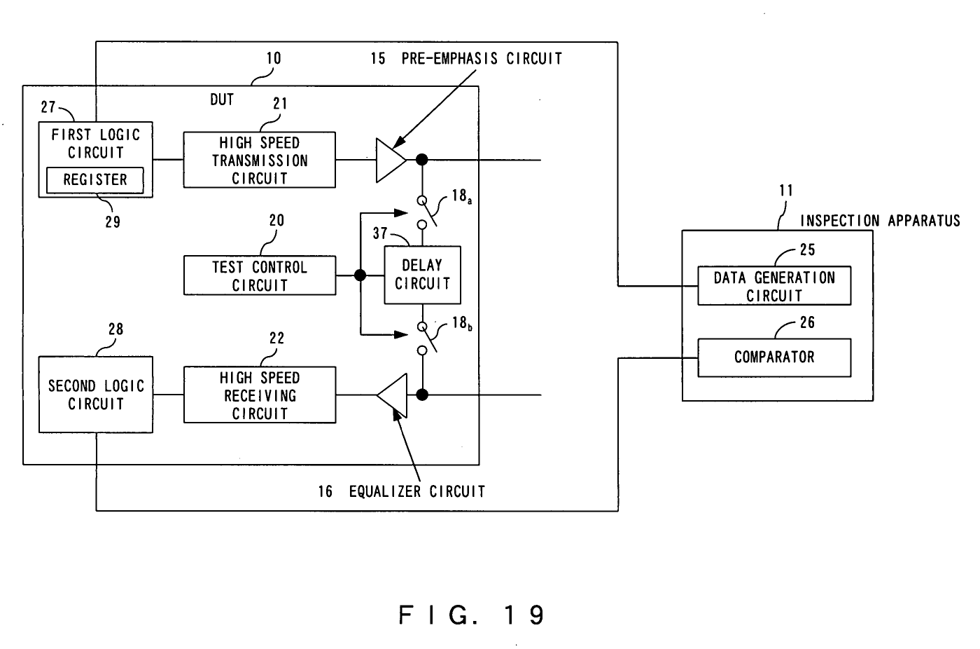

FIG. 19 is a block diagram of a third embodiment showing a comprisal of a semiconductor integrated circuit and its testing system according to the present embodiment. Comparing FIG. 19 with FIG. 3, the difference lies in that the former comprises, in place of the circuit 17, a delay circuit 37 for delaying a signal input from the pre-emphasis circuit 15 to provide to the equalizer circuit 16 as an input signal thereto.

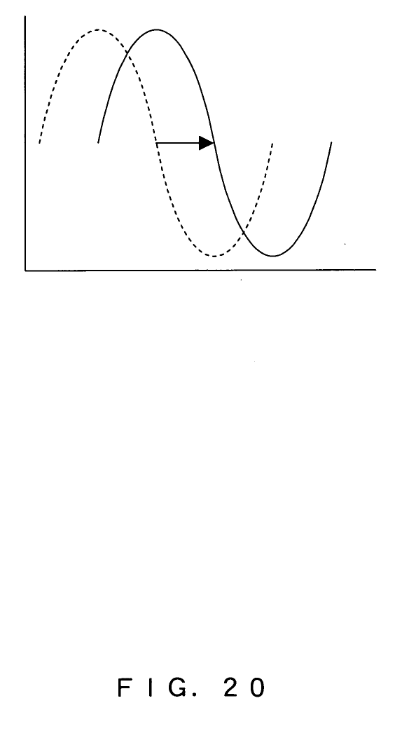

FIG. 20 describes a control by the delay circuit 37 according to the third embodiment. The delay circuit 37 accomplishes delay control of the signal.

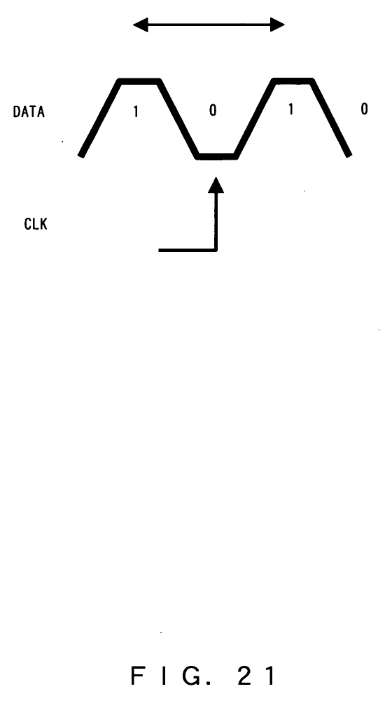

FIG. 21 describes timing control between data and a clock as a result of operation by the delay circuit 37 according to the third embodiment. As shown by FIG. 20, it is possible to provide a delay to the signal as data, control the timing between data and a clock discretionarily, and inspect the operations such as setup or hold on the side of the receiving circuit 22.

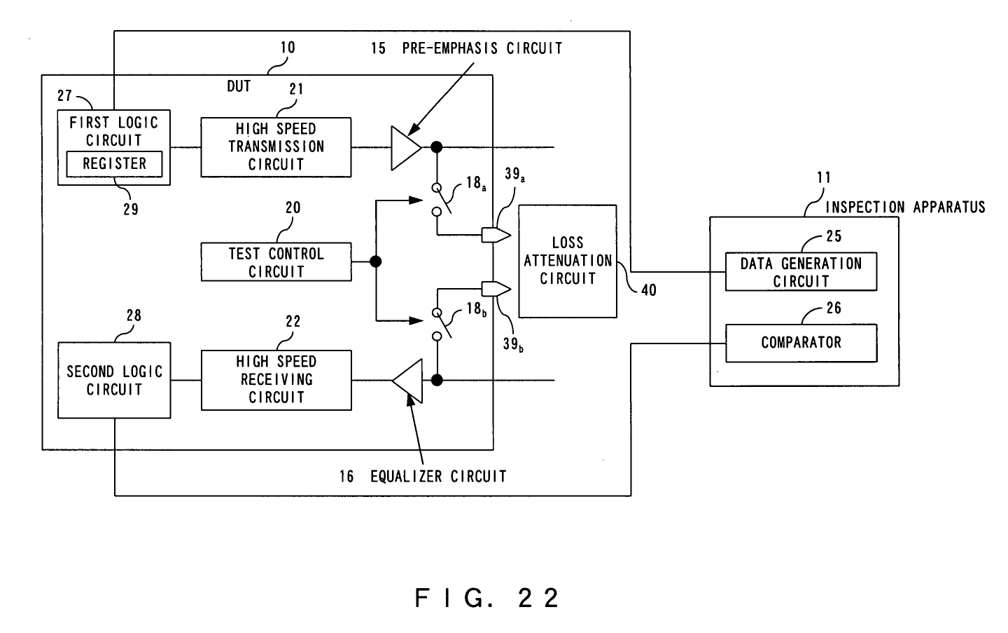

FIG. 22 is a block diagram of a fourth embodiment showing a comprisal of a semiconductor integrated circuit and its testing system. While the first, second and third embodiments are configured to accomplish the respective circuits, i.e., loss, control and delay circuits, inserted between the output side of the pre-emphasis circuit 15 and the input side of the equalizer circuit 16 at the time of testing basically by using a circuit element, PAD or parasitic capacitance of the wiring inside a semiconductor integrated circuit, the fourth embodiment is configured to equip external output terminals 39a and 39b on a chip on which an integrated circuit is mounted and connect a loss attenuation circuit 40 constituted by active and passive elements external to the semiconductor integrated circuit, thereby enabling the testing thereof. Since those active and passive elements constituting the loss attenuation circuit 40 can be applied to common components, the loss attenuation circuit 40 can be comprised ideally, regardless of production variance of the semiconductor integrated circuit.

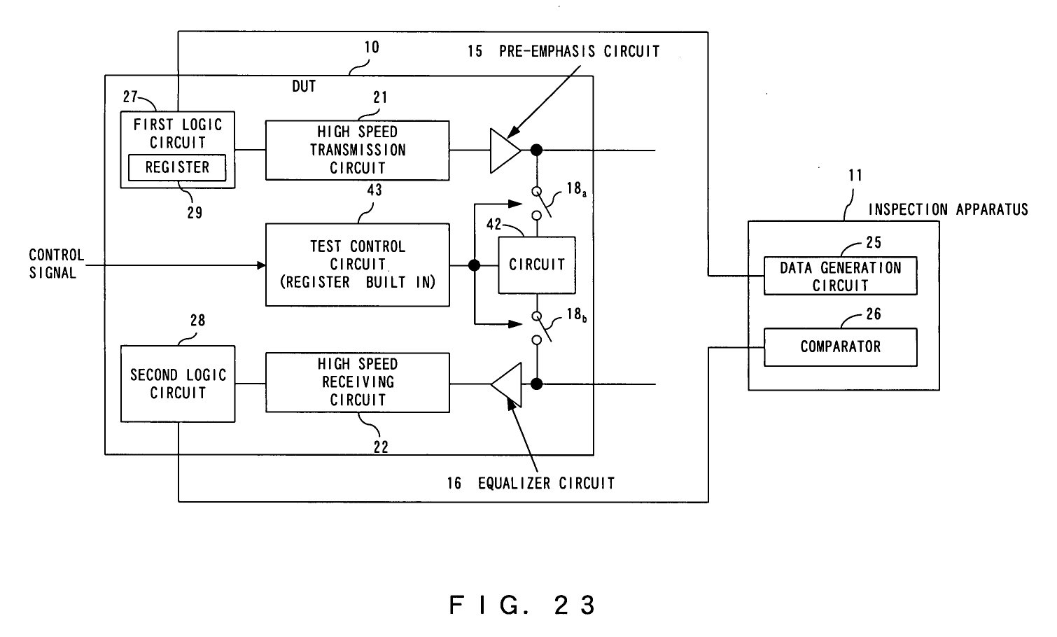

FIG. 23 is a block diagram of a fifth embodiment showing a comprisal of a semiconductor integrated circuit and its testing system. In FIG. 23, the difference between the basic comprisal block diagram shown by FIG. 3 lies in that a test control circuit 43 with a built-in register controls a circuit 42 which is inserted between the output side of the pre-emphasis circuit 15 and the input side of the equalizer circuit 16. Here, the circuit 43 is configured to include a series of circuits such as the loss circuit 30, control circuit 31 and delay circuit 37 according to the first, second and third embodiments, respectively, for example, in which a control signal from the test control circuit 43 with a built-in register uses circuits specified by the aforementioned control signal among these circuits, thereby carrying out testing of the semiconductor integrated circuit.

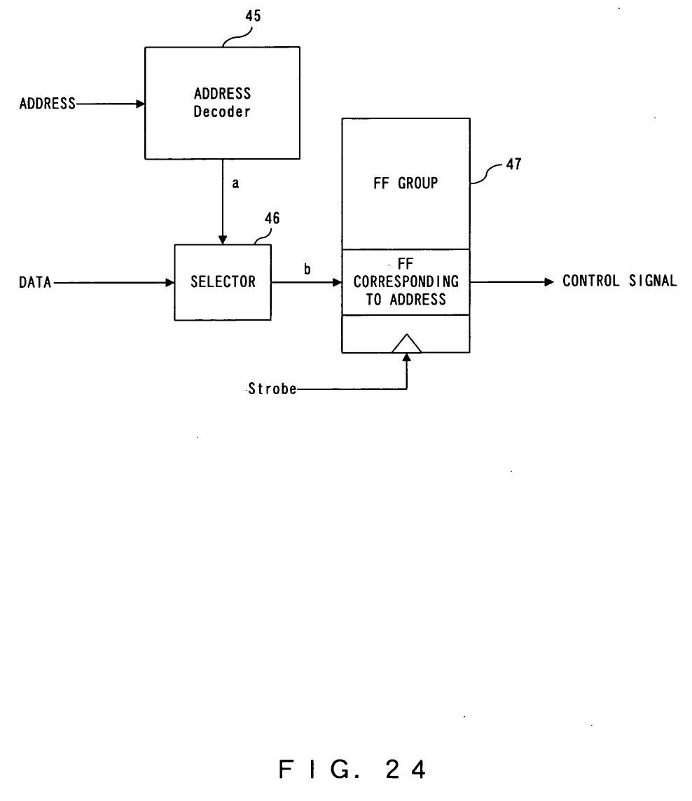

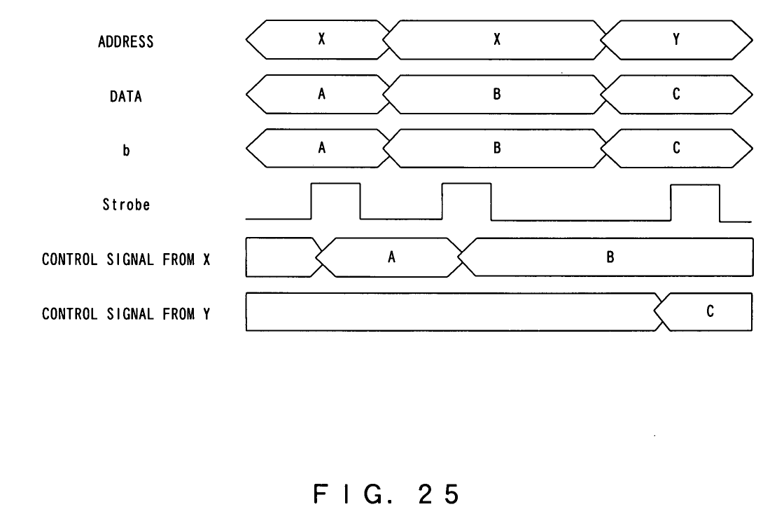

FIG. 24 is a block diagram showing a comprisal of a test control circuit according to the fifth embodiment; and FIG. 25 is an operation time chart of the test control circuit. In FIG. 24, an address specifying a corresponding FF (flip flop), among FF group 47 which are equivalent to registers, is provided to an address decoder 45. An FF, as an output destination of the data input from the outside, is selected by a selector 46 in accordance with a signal “a” output from the address decoder 45; data “b” stored by the aforementioned FF at the time of input a strobe signal is provided to the circuit 42 shown by FIG. 23 as a control signal; and testing of the semiconductor integrated circuit is carried out in the form of connecting a circuit to be used between the output side of the pre-emphasis circuit 15 and the input side of the equalizer circuit 16, for example.

Referring to FIG. 25, first data A, then data B, are provided to the selector 46 from the outside, and “X” is specified as the address corresponding to a FF in which the data are to be stored. In response to this, the data A, and then the data B, are output from the selector 46 as data to be stored in the FF, and the stored data A and B are output sequentially as control signals at the time of input of the strobe signal to the FF corresponding to the address. Subsequently, “Y” is specified as an address at the time of inputting data C from the outside, and the data C stored by a FF corresponding to the address Y is output as a control signal at the time of input of a strobe signal.

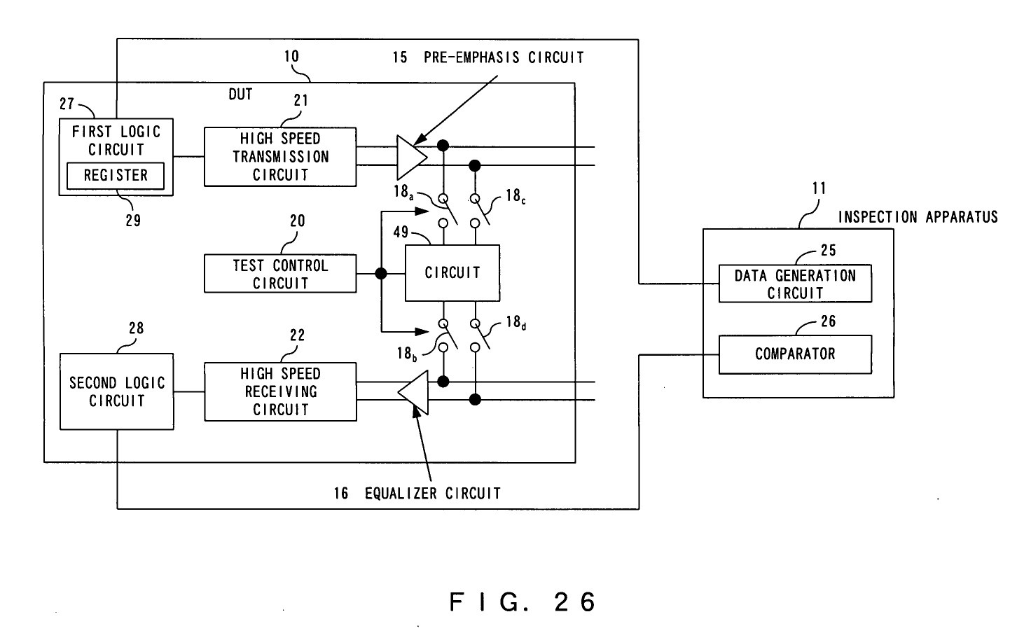

FIG. 26 is a block diagram of a sixth embodiment showing a comprisal of a semiconductor integrated circuit and its testing system. The descriptions of the sixth embodiment and thereafter relate to a differential circuit which is often used for communication circuits utilizing a high frequency signal, a communication-use semiconductor integrated circuit utilizing a differential circuit which uses a differential amplifier for example and an embodiment relevant to its testing system.

In a communication-use semiconductor integrated circuit utilizing such a differential circuit, two strings of signals, e.g., a signal corresponding to a noninverted input to the differential amplifier and a signal corresponding to an inverted input, are utilized as signals to be transmitted, resulting in equipping a circuit 49 inserted between the output side of the pre-emphasis circuit 15 and the input side of the equalizer circuit 16 corresponding to the two signal lines also in the sixth embodiment shown by FIG. 26. Note that the signal between the first logic circuit 27 and the high speed transmission circuit 21 can also be differential signals for example, but the present embodiment is not configured to use a differential signal between the aforementioned two circuits.

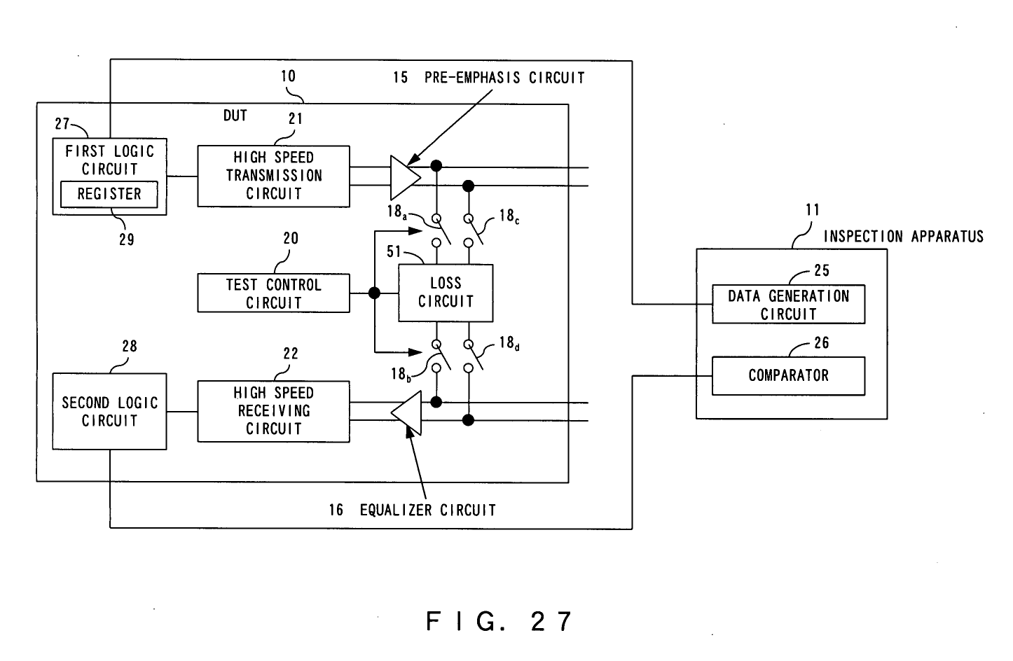

FIG. 27 is a block diagram of a seventh embodiment showing a comprisal of a semiconductor integrated circuit and its testing system. In FIG. 27, a loss circuit 51 resembling the first example shown by FIG. 5 is comprised as a circuit inserted between the output side of the pre-emphasis circuit 15 and the input side of the equalizer circuit 16 in relation to two signal lines corresponding to the differential circuit as with the sixth embodiment shown by FIG. 26. Note that the seventh embodiment is configured to insert basically the same loss circuit for the two signal lines equivalent to non-inverted and inverted signals in relation to a differential amplifier for example, thereby carrying out testing of the semiconductor integrated circuit. Moreover, it is of course possible to use the same control circuit as that of the second embodiment in place of the loss circuit 51.

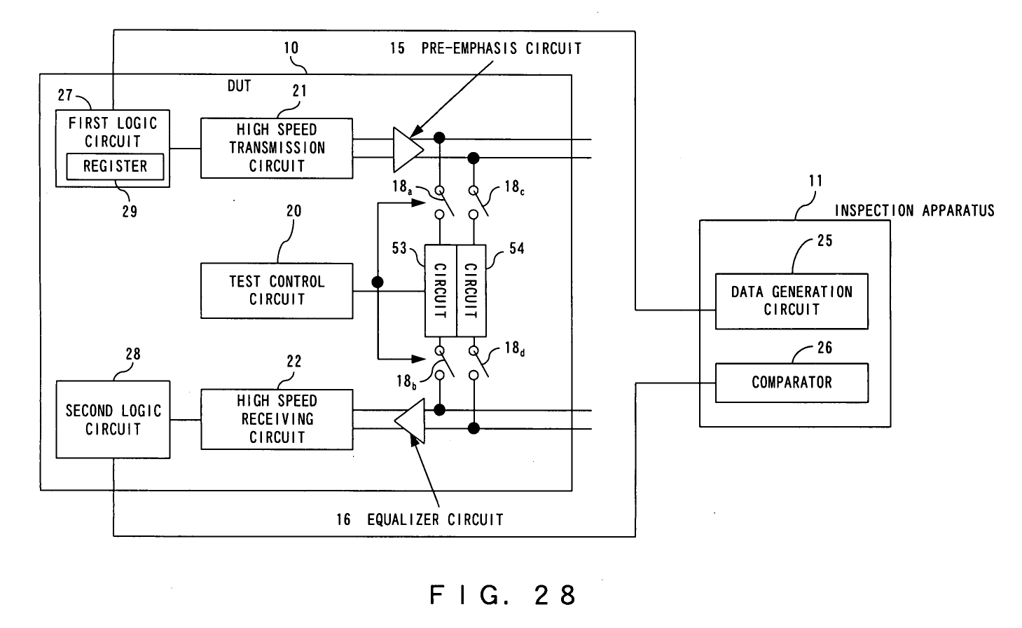

FIG. 28 is a block diagram of an eighth embodiment showing a comprisal of a semiconductor integrated circuit and its testing system. As with the sixth and seventh embodiments, the eighth embodiment is an example of an application to a differential amplifier, in which generally, two different circuits 53 and 54 are inserted between the output side of the pre-emphasis circuit 15 and the input side of the equalizer circuit 16 in relation to two signal lines, respectively, which are equivalent to non-inverted and inverted signals of a differential amplifier for example, thereby carrying out testing of a semiconductor integrated circuit.

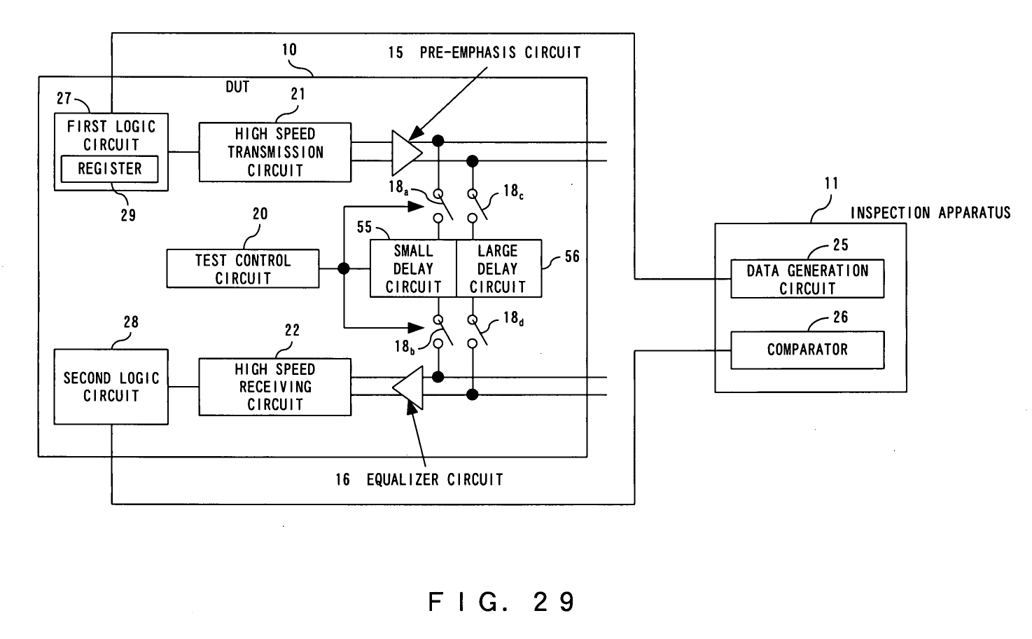

FIG. 29 is a block diagram of a ninth embodiment showing a comprisal of a semiconductor integrated circuit and its testing system. In FIG. 29, two delay circuits, i.e., a circuit 55 with a small delay and a circuit 56 with a large delay are inserted, in place of the two circuits 53 and 54 comprised in the eighth embodiment shown by FIG. 28, thereby enabling testing of the influence of the two delay circuits being inserted into the two differential signal lines respectively.

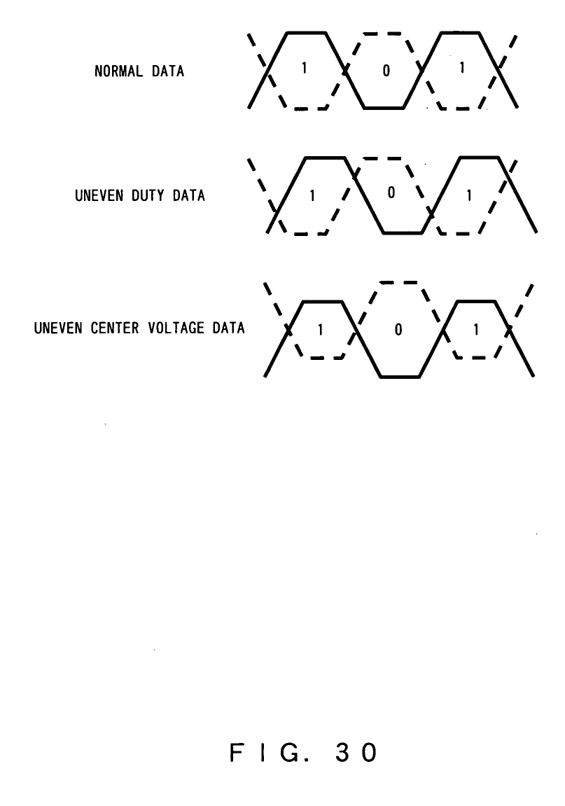

FIG. 30 describes example input signals of the equalizer circuit 16 according to the eighth and ninth embodiments. In FIG. 30, the top waveform is normal data output from the pre-emphasis circuit 15, for example, of which the solid line waveform and the dotted line are input to the large delay circuit 56 and small delay circuit 55, respectively, for example.

The waveform shown in the center of FIG. 30 indicates an input waveform of the equalizer circuit 16 in this case. A difference in the delays causes a displacement between the waveforms indicated by the solid line and the dotted line.

The bottom waveform in FIG. 30 indicates an input waveform of the equalizer circuit 16 as a result of controlling the center voltages respectively of the signal of two signal lines independently as in the case of the second embodiment for example, thereby providing the equalizer circuit 16 a waveform with the center voltages for the solid line waveform and the dotted line waveform of different center voltages.

As has been described in detail, the present invention enables testing inclusive of the influences caused by not only a transmission path but also a pre-emphasis circuit and equalizer circuit, and further influences caused by various circuits such as a loss circuit, a circuit for controlling the center voltage or amplitude, a delay circuit, et cetera, when they are inserted as described.

The preferred embodiments according to the present invention also include as follows:

1. A semiconductor integrated circuit which comprises a transmission and receiving circuits, characterized by comprising:

two external connection terminals for connecting to the inserted circuit for receiving an output of the transmission circuit and providing the output signal to the receiving circuit, and

a switch for connecting the two external connection terminals between an output side of the transmission circuit and an input side of the receiving circuit

so as to enable a connection of a circuit which provides a change in an output signal of the transmission circuit with the external connection circuit.

2. A semiconductor integrated circuit which comprises a transmission circuit for transmitting a differential signal and a receiving circuit for receiving one, characterized by comprising:

an inserted circuit for receiving an output differential signal from the transmission circuit and providing an output differential signal to the receiving circuit; and

a switch for connecting the inserted circuit between an output side of the transmission circuit and an input side of the receiving circuit.

3. The semiconductor integrated circuit noted by the paragraph 2 above, characterized by the above mentioned inserted circuit providing a loss to an output differential signal output by the above mentioned transmission circuit, thereby providing the resultant output differential signal with the provided loss to the above mentioned receiving circuit.

4. The semiconductor integrated circuit noted by the paragraph 2 above, characterized by the above mentioned inserted circuit being a voltage control circuit for controlling a center voltage of an output differential signal output by the abovementioned transmission circuit in such a way as to make it higher or lower.

5. The semiconductor integrated circuit noted by the paragraph 2 above, characterized by the above mentioned inserted circuit being a voltage control circuit for controlling an amplitude of an output differential signal output by the above mentioned transmission circuit in such a way as to make it larger or smaller.

6. The semiconductor integrated circuit noted by the paragraph 2 above, characterized by the above mentioned inserted circuit being a signal delay circuit for delaying an output differential signal output by the above mentioned transmission circuit.

7. The semiconductor integrated circuit noted by the paragraph 2 above, characterized by further comprising:

a control data storage unit for storing data for controlling an operation of the above mentioned inserted circuit, and

a test control circuit for controlling an operation of the above mentioned inserted circuit in accordance with storage content of the control data storage unit.

8. The semiconductor integrated circuit noted by the paragraph 2 above, characterized by comprising:

a pre-emphasis circuit for emphasizing a high frequency component of an output differential signal at a later stage of the above mentioned transmission circuit, and an equalizer circuit for equalizing a receiving differential signal at an earlier stage of

the above mentioned receiving circuit, in which the above mentioned inserted circuit and switch are connected between an output side of the pre-emphasis circuit and an input side of the equalizer circuit.

9. A semiconductor integrated circuit which comprises a transmission circuit for transmitting a differential signal and a receiving circuit for receiving one, characterized by comprising:

two external connection terminals which are to be connected with an inserted circuit for receiving an output differential signal output by the transmission circuit and providing one to the receiving circuit; and

a switch for connecting the two external connection terminals between an output side of the transmission circuit and an input side of the receiving circuit,

so as to enable a connection of the external connection terminals with a circuit which provides a change to an output differential signal output by the above mentioned transmission circuit.

10. A semiconductor integrated circuit comprising a transmission circuit for transmitting a high speed differential signal with a high transfer rate and a receiving circuit for receiving one, characterized by comprising:

a first logic circuit for converting an externally input low speed signal with a low transfer rate to a high speed signal with a high transfer rate to provide to the transmission circuit at the time of testing the semiconductor integrated circuit;

an inserted circuit for receiving an output differential signal output by the transmission circuit and providing one to the receiving circuit;

a switch for connecting the inserted circuit between an output side of the transmission circuit and an input side of the receiving circuit at the time of the testing; and

a second logic circuit for converting a high speed signal output from the receiving circuit into a low speed signal to output to the outside at the time of the testing.

11. A testing method used for a semiconductor integrated circuit comprising a transmission circuit for transmitting a high speed differential signal with a high transfer rate and a receiving circuit for receiving a high speed differential signal, characterized by comprising the steps of

converting an externally input low speed signal with a low transfer rate into a high speed signal and inputting it to the transmission circuit;

inputting an output differential signal of the transmission circuit, for testing the semiconductor integrated circuit, to the inserted circuit which is inserted between the transmission circuit and receiving circuit;

converting a high speed signal, to a low speed signal, output from a transmission circuit to which an output differential signal of the inserted circuit is input; and

comparing the converted low speed signal with an expected value of the test result.

What is claimed is:

1. A semiconductor integrated circuit comprising a transmission circuit and a receiving circuit, comprising:
an inserted circuit for receiving an output signal of the transmission circuit and providing the output signal to the receiving circuit; and
a switch for connecting the inserted circuit between an output side of the transmission circuit and an input side of the receiving circuit.

2. The semiconductor integrated circuit according to claim 1, wherein said inserted circuit provides a loss to an output signal of said transmission circuit and provides an output signal as a result of the loss being provided to said receiving circuit.

3. The semiconductor integrated circuit according to claim 1, wherein said inserted circuit is a voltage control circuit for controlling a center voltage level of an output signal of the said transmission circuit by increasing or decreasing the level.

4. The semiconductor integrated circuit according to claim 1, wherein said inserted circuit is a voltage control circuit for controlling the signal amplitude of an output signal of said transmission circuit by increasing or decreasing it.

5. The semiconductor integrated circuit according to claim 1, wherein said inserted circuit is a signal delay circuit for delaying an output signal of said transmission circuit.

6. The semiconductor integrated circuit according to claim 1, further comprising
a control data storage unit for storing data for controlling an operation of said inserted circuit, and a test control circuit for controlling an operation of said inserted circuit in accordance with a storage content of the control data storage unit.

7. The semiconductor integrated circuit according to claim 1, further comprising
a pre-emphasis circuit for emphasizing a high frequency component of an output signal at a later stage of said transmission circuit, and an equalizer circuit for equalizing an output signal at an earlier stage of said receiving circuit, wherein
said inserted circuit and switch are connected between an output side of the pre-emphasis circuit and an input side of the equalizer circuit.

8. A semiconductor integrated circuit comprising a transmission circuit for transmitting a high-speed signal with a high transfer rate and a receiving circuit for receiving a high speed signal, comprising:
a first logic circuit for converting an externally input low speed signal with a low transfer rate into a high speed signal with a high transfer rate to provide to the transmission circuit at the time of testing the semiconductor integrated circuit;
an inserted circuit for receiving an output signal of the transmission circuit and providing one to the receiving circuit;
a switch for connecting the inserted circuit between an output side of the transmission circuit and an input side of the receiving circuit at the time of the testing; and
a second logic circuit for converting a high speed signal output from the receiving circuit into a slow speed signal to output to the outside at the time of the testing.

9. A testing method used for a semiconductor integrated circuit comprising a transmission circuit for transmitting a high speed signal with a high transfer rate and a receiving circuit for receiving a high speed signal, comprising the steps of
converting an externally input low speed signal with a low transfer rate into a high speed signal and inputting it to the transmission circuit;
inputting an output of the transmission circuit, for testing the semiconductor integrated circuit, to the inserted circuit which is inserted between the transmission circuit and receiving circuit;
converting a high speed signal, to a low speed signal, output from a receiving circuit to which an output of the inserted circuit is input; and
comparing the converted low speed signal with an expected value of a test result.
